(19) United States
(12) Patent Application Publication
(10) Pub. No.: US 2016/0096497 A1
(43) Pub. Date: Apr. 7, 2016

(54) BUMPER PROTECTOR FOR TRAILER

(71) Applicant: Rommy Lashone Pyatt, Ladson, SC (US)

(72) Inventor: Rommy Lashone Pyatt, Ladson, SC (US)

(21) Appl. No.: 14/505,199

(22) Filed: Oct. 2, 2014

(51) Int. Cl. B60R 19/42; B60R 19/03; B60R 19/24

(52) U.S. Cl. CPC B60R 19/42; B60R 19/24; B60R 19/03

(57) ABSTRACT

A shock absorbing apparatus for a trailer is provided. The shock absorbing apparatus includes a frame. The frame includes an elongated length (I), a front side and a rear side. The present invention may further include a compressible bumper attached to the frame along the elongated length and extending from the front side. The compressible bumper may be made of rubber or other compressible polymer. The present invention may further include at least one hook protruding from the rear side of the frame. The hook may releasably attach to a side rail of a trailer.

### BACKGROUND OF THE INVENTION

The present invention relates to unloading trailers and, more particularly, to a bumper for preventing damage when unloading trailers.

Currently, when unloading goods from a trailer, lift trucks come in contact with the aluminum side rails of the trailer with enough force to damage the rails. The impact of the lift trucks compresses the soft aluminum, thereby preventing tie down strap hooks from passing through the openings behind the rail to tie goods to the trailer.

As can be seen, there is a need for a bumper that prevents the damage to the trailer.

### SUMMARY OF THE INVENTION

In one aspect of the present invention, a shock absorbing apparatus comprises: an frame comprising an elongated length, a front side and a rear side; a compressible bumper attached to the frame along the elongated length, and extending from the front side; and at least one hook protruding from the rear side of the frame and configured to releasably attach to a side of a trailer.

In another aspect of the present invention, a method of providing a shock absorber for a trailer comprising: providing a frame comprising an elongated length, a front side and a rear side; a compressible bumper attached to the frame along the elongated length, and extending from the front side; and at least one hook protruding from the rear side of the frame; and hooking the at least one hook of the frame to a side of a trailer prior to unloading the trailer.

These and other features, aspects and advantages of the present invention will become better understood with reference to the following drawings, description and claims.

### BRIEF DESCRIPTION OF THE DRAWINGS

FIG. 1 is a perspective view of and embodiment the present invention shown in use;

FIG. 2 is a perspective view of an embodiment of the present invention;

FIG. 3 is a rear perspective view of an embodiment of the present invention;

FIG. 4 is an exploded view of an embodiment of the present invention;

FIG. 5 is a detailed section view taken along line 5-5 in FIG. 1; and

FIG. 6 is a detailed section view taken along line 6-6 in FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a rubber bumper device that prevents damage to a commercial flat-bed trailer's tie down rail system. The present invention includes a protective cushion between the lift truck and the aluminum rail system. The present invention may include a support frame installed with clips to be slipped over the trailer rails for easy repositioning along the rail systems. The present invention is not permanently attached to any structures, and can easily be transferred or repositioned. The bumper may be about 2″×6′ D type rubber bumper, and the frame may be about 1.5″×6′ beam made of aluminum with up to five support clips.

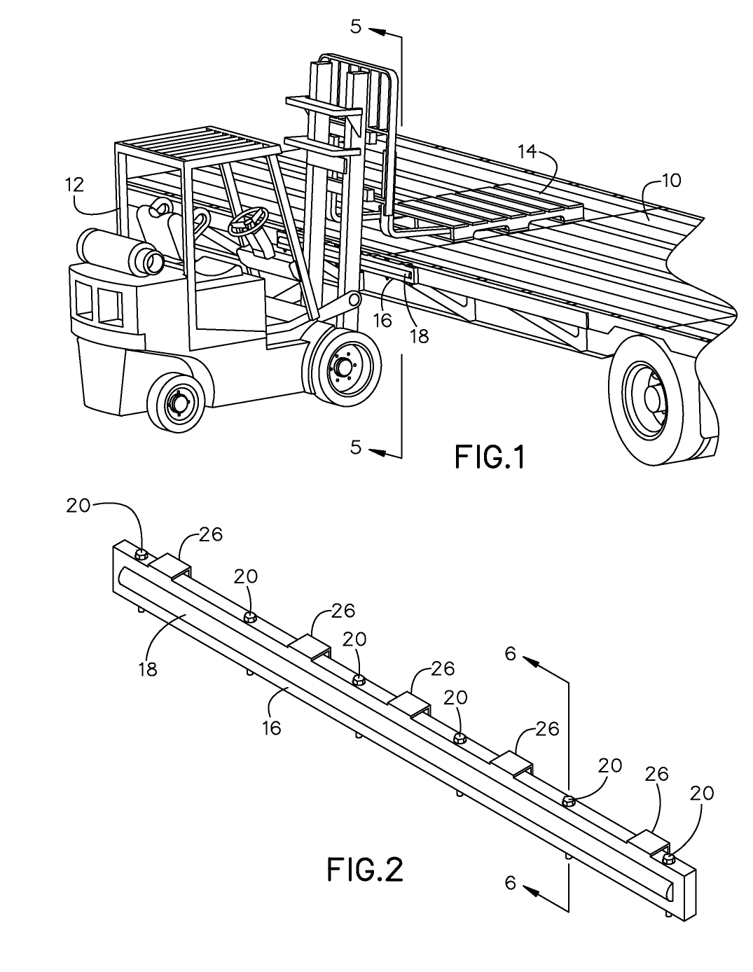

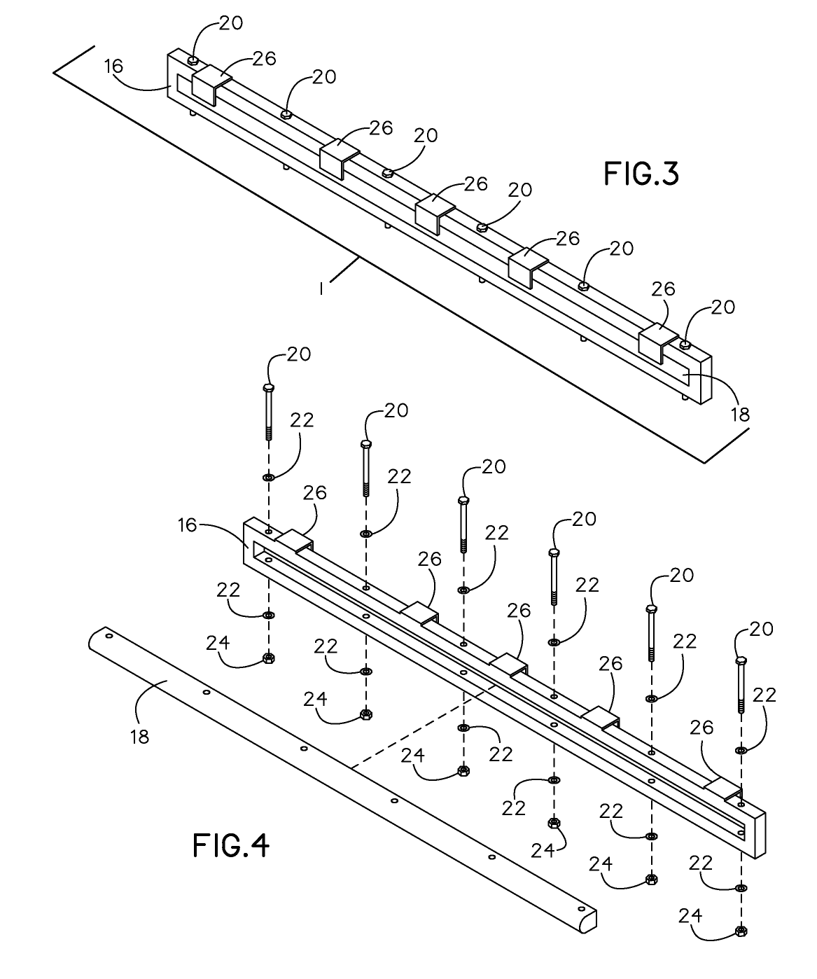

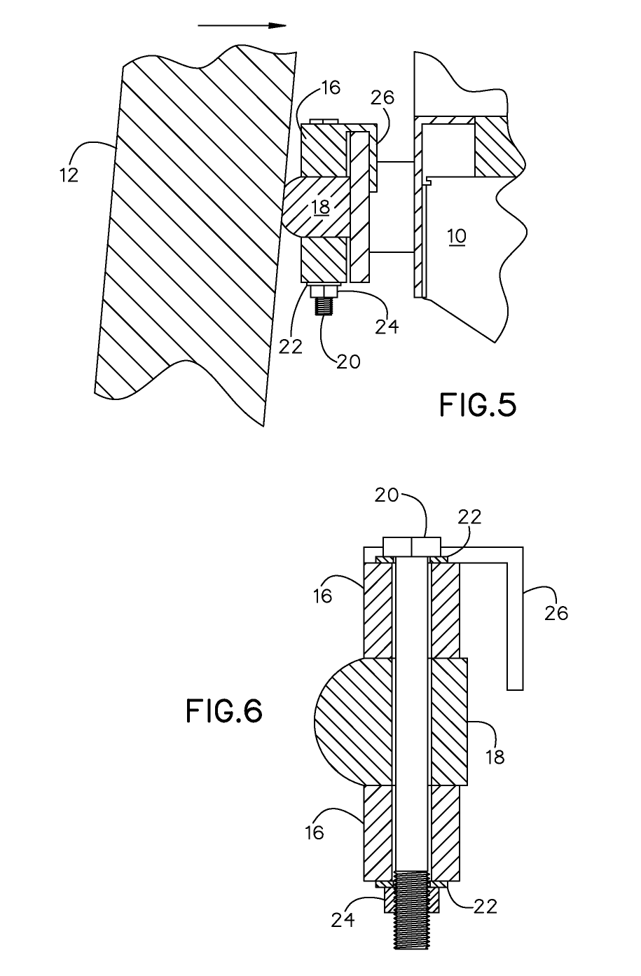

Referring to FIGS. 1 through 6, the present invention includes a shock absorbing apparatus. The shock absorbing apparatus includes a frame 16. The frame 16 includes an elongated length (I), a front side and a rear side. The present invention may further include a compressible bumper 18 attached to the frame along the elongated length and extending from the front side. The compressible bumper 18 may be made of rubber or other compressible polymer. The present invention may further include at least one hook 26 protruding from the rear side of the frame 16. The hook 26 may releasably attach to a side rail of a trailer 10.

As mentioned above, the frame 16 may be made of aluminum. However, the frame 16 may be made of any appropriate strong materials, such as steel, iron, and the like. In certain embodiments, the frame 16 may include an elongated channel formed along the length. The elongated channel may house the bumper 18 within. In such embodiments, the frame 16 may include a plurality of frame apertures. The bumper 18 may include a plurality of bumper apertures that align with the plurality of frame apertures. A plurality of plurality of bolts 20 may run through each of the aligned plurality of frame apertures and the plurality of bumper apertures. The bolts 20 may be secured by washers 22 and lock nuts 24, thereby securing the compressible bumper 18 to the frame 16.

In certain embodiments, the at least one hook 26 may include a plurality of hooks 16 attached along the length (I) of the frame 16. In certain embodiments, the plurality of hooks 26 are welded to a top edge of the frame 16, extending away from the frame 16 and extending downwards, thereby forming the hook 26. The hooks 26 may be placed within the space created in between the rail and the trailer 10, and thereby securing the rail.

A method of using the present invention may include the following. A person may attach or hook the present invention onto the rails of their trailer 10 where the fork truck 12 would ordinarily come in contact with the rails. If the person only has one of device, the person can simply move it to the desired location to prevent any contact from lift trucks 12. If the person has more than one of the present invention, he/she can attach or hook those devices along the rail system where the lift truck 12 may come in contact with the rail system. The user may use the lift truck 12 to remove cargo 14 from the trailer. When the person is finished using the present invention, he/she can easily remove them from the rail system and store them under the trailer 10 where he/she would normally store dunnage.

It should be understood, of course, that the foregoing relates to exemplary embodiments of the invention and that modifications may be made without departing from the spirit and scope of the invention as set forth in the following claims.

What is claimed is:

1. A shock absorbing apparatus comprising:
an frame comprising an elongated length, a front side and a rear side;
a compressible bumper attached to the frame along the elongated length, and extending from the front side; and
at least one hook protruding from the rear side of the frame and configured to releasably attach to a side of a trailer.

2. The shock absorbing apparatus, wherein an elongated channel is formed in the frame, wherein the compressible bumper is secured within the elongated channel.

3. The shock absorbing apparatus of claim 2, wherein the frame comprises a plurality of frame apertures and the compressible bumper comprises a plurality of bumper apertures that align with the plurality of frame apertures, wherein a plurality of bolts run through each of the aligned plurality of frame apertures and the plurality of bumper apertures, thereby securing the compressible bumper to the frame.

4. The shock absorbing apparatus of claim 1, wherein the at least one hook comprises a plurality of hooks attached along the length of the frame.

5. The shock absorbing apparatus of claim 5, wherein the plurality of hooks are welded to a top edge of the frame, extending away from the frame and extending downwards, thereby forming the hook.

6. The shock absorbing apparatus of claim 1, wherein the compressible bumper is rubber.

7. A method of providing a shock absorber for a trailer comprising:
providing a compressible bumper having an elongated length and at least one hook protruding from the compressible bumper; and
hooking the at least one hook of the frame to a side of a trailer prior to unloading the trailer.

8. The method of claim 7, wherein the at least one hook is a plurality of hooks attached along the length of the frame.

9. The method of claim 7, wherein an elongated channel is formed in the frame, wherein the compressible bumper is secured within the elongated channel.

10. The method of claim 7, wherein the compressible bumper is rubber.
